(19) United States
(12) Patent Application Publication
(10) Pub. No.: US 2009/0288613 A1
(43) Pub. Date: Nov. 26, 2009

(54) Pet Cage Assembly

(76) Inventor: Ying-Kuan Ho, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/123,520

(22) Filed: May 20, 2008

(51) Int. Cl. A01K 1/03; A01K 31/08

(52) U.S. Cl. 119/482

(57) ABSTRACT

A pet cage assembly comprises two lateral panels, a front panel, a rear panel, a bottom panel and a top panel. Each of the lateral panels comprises an upper and a lower sub-panel, each formed with fasteners extending inwards from two ends thereof for engaging with cavities formed on corresponding edges of the front and rear panels. Each of the lower sub-panels is formed with an extended, engaging portion adjacent to a section thereof to which the front panel is assembled, so that the front panel can be retained bilaterally by the engaging portions. The lateral, front and rear panels are fastened to a bottom side of the top panel, which is formed with an opening for receiving an upper door resiliently engaged therein. The rear panel comprises a frame pivotally attached by a rear door, which is resiliently engaged at an edge thereof with the frame.

### BACKGROUND OF THE INVENTION

1. Technical Field

The present invention relates to a pet cage assembly for transporting pets (such as doves), and more particularly, to a pet cage assembly which can be securely assembled by engaging components thereof with one another.

2. Description of Related Art

A pet cage assembly designed for carrying pets (such as doves) out for training or competition is usually integrally formed with a front panel, a rear panel, two lateral panels and a bottom panel, all of which have a predetermined width; and then pivotally connected with a top panel having a small upper door. However, such pet cage assemblies take up a lot of space, and are therefore difficult to be loaded into a car immediately after they are purchased from a store. Although pets (such as doves) can be put into the pet cage assemblies and then carried out conveniently, when the pets (such as doves) are released for training or competition so that the pet cage assemblies are no more needed, it is again inconvenient to load the empty pet cage assemblies into a car to take them back because the pet cage assemblies, though empty, still occupy much space as they cannot be collapsed or folded up.

### BRIEF SUMMARY OF THE INVENTION

Therefore, the present invention aims to improve existing pet cage assemblies regarding the inconvenience resulting from loading them into a means of transportation when they are not in use. It is desirable to have a pet cage assembly for carrying pets (such as doves) out that can be securely assembled by engaging components thereof with one another.

A primary objective of the present invention is to provide a pet cage assembly comprising two lateral panels, a front panel, a rear panel, a bottom panel and a top panel. Each of the lateral panels is composed of an upper sub-panel and a lower sub-panel, wherein the upper and lower sub-panels are each formed with fasteners extending inwards from two ends thereof, for being fastened with cavities formed on corresponding edges of the front and rear panels while being assembled. In addition, the lower sub-panel of each of the lateral panels is formed with an extended, engaging portion adjacent to a section of the lower sub-panel to which the front panel is assembled, so that the front panel can be retained bilaterally by the engaging portions formed on the lower sub-panels of the two lateral panels while being assembled. The lateral, front and rear panels are fastened to a bottom side of the top panel, which is formed with an opening for receiving an upper door resiliently engaged therein. The rear panel comprises a frame having a predetermined width and a rear door pivotally attached thereto, wherein the rear door is resiliently engaged at an edge thereof with the frame. The pet cage assembly can be stably assembled by simply engaging the lateral, front, rear, bottom and top panels with one another.

### BRIEF DESCRIPTION OF THE SEVERAL VIEWS OF THE DRAWINGS

The invention as well as a preferred mode of use, further objectives and advantages thereof will best be understood by reference to the following detailed description of an illustrative embodiment when read in conjunction with the accompanying drawings, wherein:

FIG. 1 is a schematic exploded view of a pet cage assembly according to the present invention;

FIG. 2 is a perspective assembled view of the pet cage assembly according to the present invention;

FIG. 3 is a schematic, partial assembled view of a front panel, an upper sub-panel and a lower sub-panel according to the present invention;

FIG. 4 is a detailed cross-sectional view taken along a line 40-40 in FIG. 3;

FIG. 5 is a schematic, partial assembled view of the upper sub-panel, the lower sub-panel, a bottom panel and a top panel according to the present invention;

FIG. 6 is a detailed cross-sectional view taken along a line 60-60 in FIG. 5;

FIG. 7 is a schematic view showing the front panel in FIG. 6 being moved;

FIG. 8 is a schematic view of a latch installed in an upper door according to the present invention when the latch is not pressed;

FIG. 9 is a detailed cross-sectional view taken along a line 90-90 in FIG. 8;

FIG. 10 is a schematic view of the latch installed in the upper door according to the present invention when the latch is pressed;

FIG. 11 is a detailed cross-sectional view taken along a line 110-110 in FIG. 10;

FIG. 12 is a schematic view of a latch installed in a rear door according to the present invention when the latch is not pressed; and

FIG. 13 is a schematic view of the latch installed in the rear door according to the present invention when the latch is pressed.

### DETAILED DESCRIPTION OF THE INVENTION

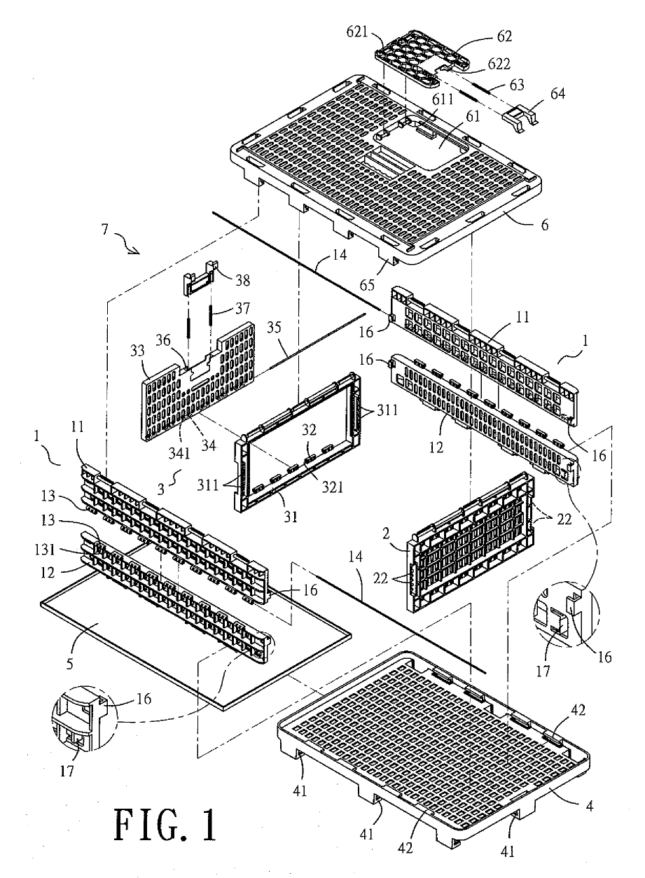

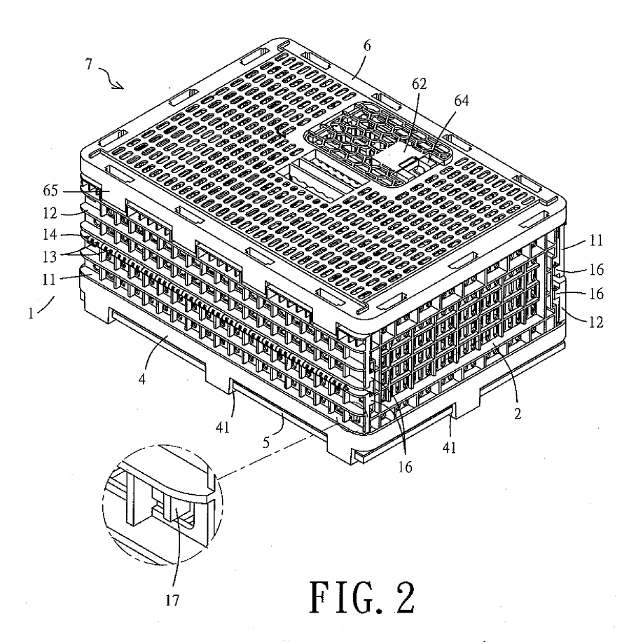

Referring to FIGS. 1 and 2, a pet cage assembly 7 according to the present invention comprises two lateral panels 1, a front panel 2, a rear panel 3, a bottom panel 4 attached with a water tray 5, and a top panel 6 combined with an upper door 62.

Each of the two lateral panels 1 is composed of an upper sub-panel 11 and a lower sub-panel 12, both of which have a predetermined width. The matching upper sub-panel 11 and lower sub-panel 12 have corresponding connecting edges formed alternately with a plurality of protrusions 13, each having a transverse through hole 131. When the matching upper sub-panel 11 and lower sub-panel 12 are put together, the through holes 131 in the protrusions 13 can be penetrated by a bar 14, so that the upper sub-panel 11 and the lower sub-panel 12 are joined to form an integral piece. In addition, each of the upper sub-panels 11 and the lower sub-panels 12 is formed with fasteners 16 extending inwards from two ends thereof. Moreover, the lower sub-panel 12 of each of the lateral panels 1 is further formed with an extended, engaging portion 17 at one of the two ends thereof. (In the embodiment disclosed herein, the engaging portion 17 is located adjacent to a section of each said lower sub-panel 12 to which the front panel 2 is assembled.)

The front panel 2 is a panel having a predetermined width and located at a front side of the pet cage assembly 7. The front panel 2 is formed with cavities 22 on two edges thereof corresponding to the fasteners 16 extending from the two ends of the upper and lower sub-panels 11, 12 of the lateral panels 1.

The rear panel 3 comprises a frame 31 having a predetermined width. The frame 31 is formed on an edge thereof (or more particularly, a lower edge thereof in the embodiment disclosed herein) with a plurality of spaced protrusions 32, each having a transverse through hole 321 for matching with a rear door 33, so that the rear door 33 can be received in the frame 31. The rear door 33 is also formed on an edge thereof (corresponding to the protrusions 32 on the frame 31) with a plurality of spaced protrusions 34, each having a transverse through hole 341. When the rear door 33 and the frame 31 are put together, the through holes 341, 321 of the protrusions 34, 32 formed respectively thereon can be penetrated by a bar 35, allowing the rear door 33 and the frame 31 to be joined and form an integral piece. The rear door 33 is further formed on another edge thereof (or more particularly, an upper edge thereof in the embodiment disclosed herein) with a recess 36. The recess 36 is installed with resilient elements 37, whose outer ends press against a latch 38 so that the latch 38 is resiliently engaged with an edge of the frame 31. In addition, the frame 31 is also formed with cavities 311 on two lateral edges thereof corresponding to the fasteners 16 extending from the two ends of the upper and lower sub-panels 11, 12 of the lateral panels 1.

The bottom panel 4 is a base having a predetermined width and formed with a plurality of supporting portions 41 along two lateral edges and another edge of a bottom side thereof, so that the water tray 5 can be movably supported by the supporting portions 41. The bottom panel 4 is further formed with a plurality of spaced edge-retaining portions 42 along two lateral edges of an upper side of the bottom panel 4, so that the lower sub-panels 12 of the two lateral panels 1 can be fastened with the edge-retaining portions 42, allowing the two lateral panels 1 and the bottom panel 4 to be joined and form an integral piece.

The top panel 6 is a cover having a predetermined width and formed with an opening 61 for receiving an upper door 62. The opening 61 is installed with supporting bars 611 for pivotally and stably connecting with a fastening portion 621 formed on an edge of the upper door 62. The upper door 26 is further formed on another edge thereof with a recess 622. The recess 622 is installed with resilient elements 63, whose outer ends press against a latch 64 so that the latch 64 is resiliently engaged with an edge of the opening 61. In addition, the top panel 6 is formed with a plurality of spaced retaining portions 65 along two lateral edges, a front edge and a rear edge of a bottom side of the top panel 6, so that the upper sub-panels 11 of the two lateral panels 1, the front panel 2 and the frame 31 of the rear panel 3 can be fastened with the retaining portions 65, allowing the top panel 6, the two lateral panels 1, the front panel 2 and the rear panel 3 to be joined and form an integral piece.

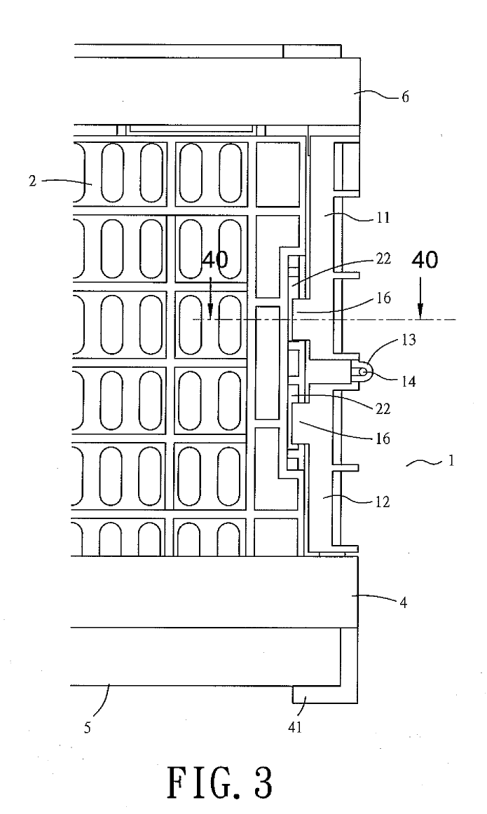

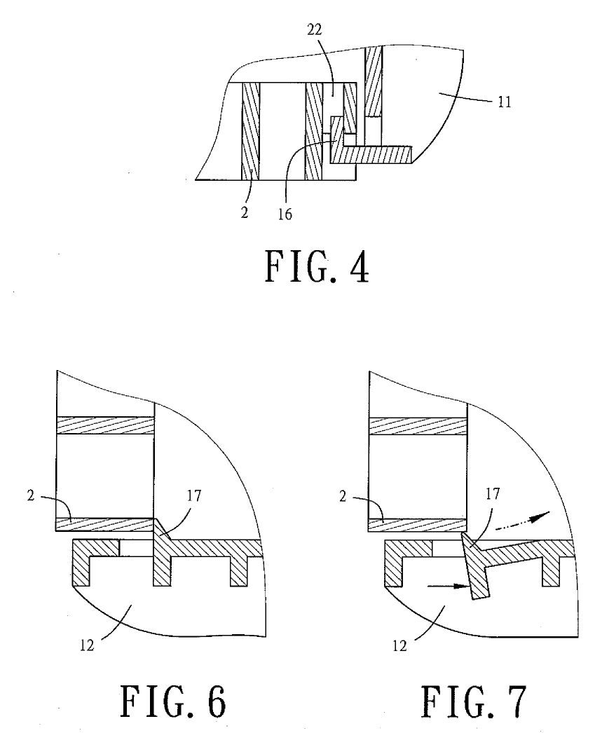

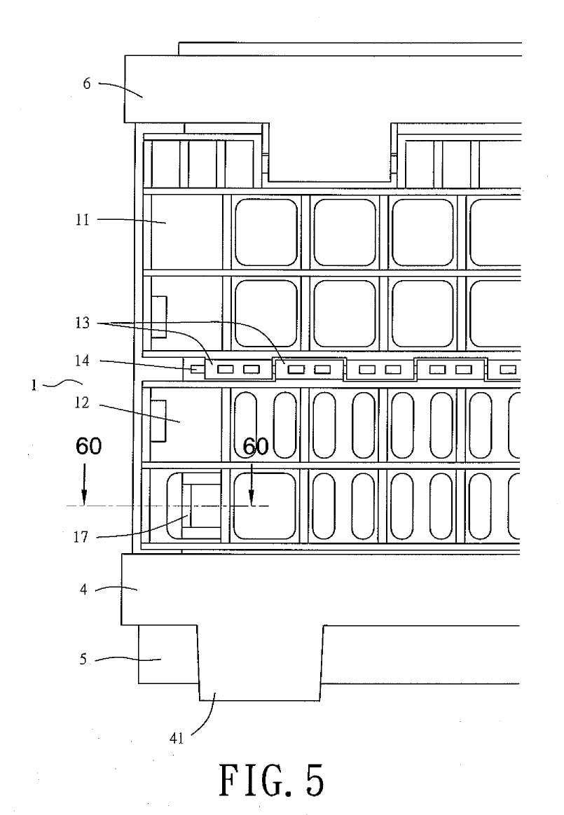

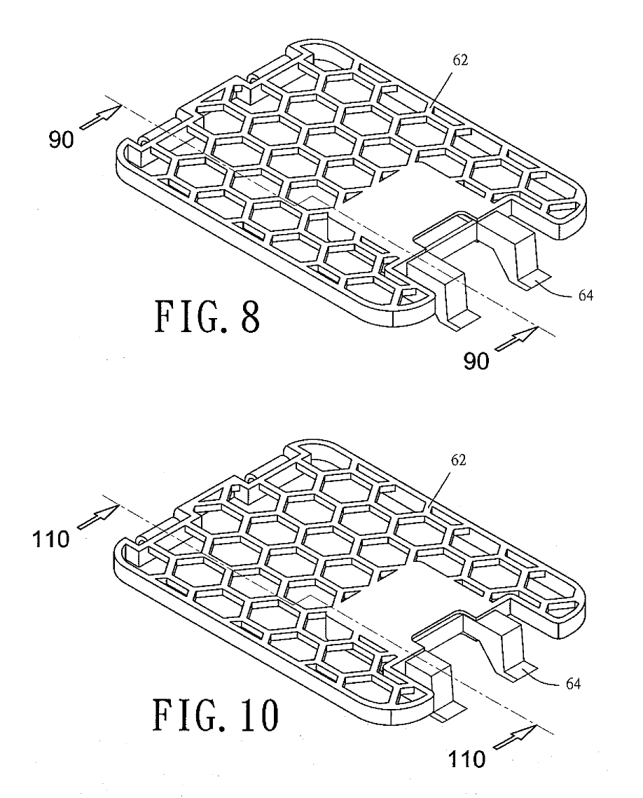

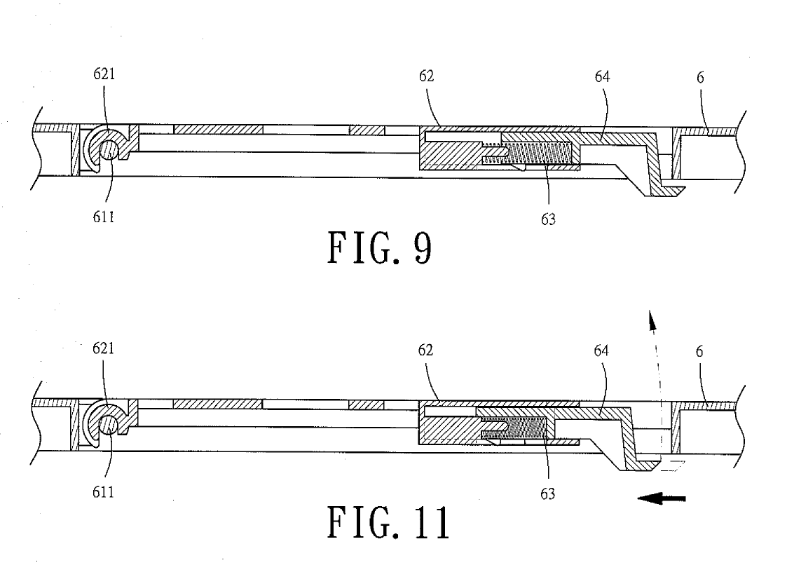

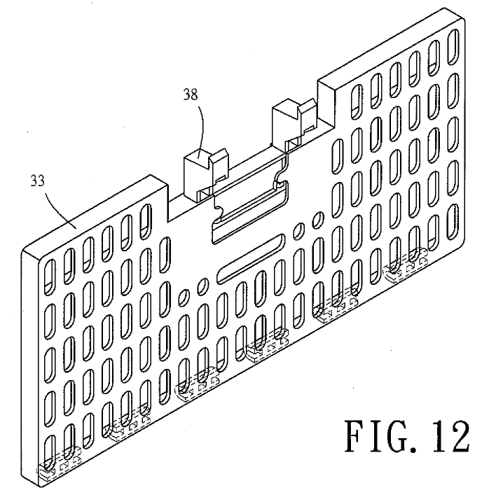

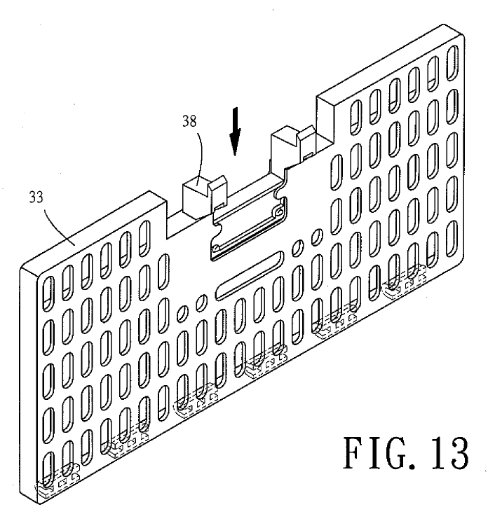

The process for assembling the pet cage assembly 7 will be given hereinafter with reference to FIGS. 1 through 3. Firstly, the adjacent protrusions 13 on the upper and lower sub-panels 11, 12 are put together, and then the bar 14 is inserted through the through holes 131, so that the upper and lower sub-panels 11, 12 are pivotally connected to form the lateral panel 1, as shown in FIG. 5. Next, the lower sub-panels 12 of the two lateral panels 1 are fastened to the edge-retaining portions 42 of the bottom panel 4. Following that, upper edges of the front panel 2 and the rear panel 3 are fastened to the corresponding retaining portions 65 formed on the bottom side of the top panel 6, and upper edges of the upper sub-panel 11 of the two lateral panel 1 are also fastened to the corresponding retaining portions 65 on the top panel 6. Finally, the fasteners 16 formed at the two ends of the upper and lower sub-panels 11, 12 of the two lateral panels 1 are fastened to cavities 22, 331 formed respectively on the front and rear panels 2, 3, as shown in FIG. 4. It should be noted that, during the assembling process, the front panel 2 which has been fastened to the top panel 6 will press against the extended, engaging portions 17 formed on the lower sub-panels 12 of the lateral panels 1 so that the engaging portions 17 are moved outwards, as shown in FIG. 7. As a result, an inner side of the front panel 2 will be retained bilaterally by the engaging portions 17 on the lower sub-panels 12, as shown in FIG. 6. (When the pet cage assembly 7 is to be collapsed and folded up, a user can push the engaging portions 17 on the lower sub-panels 12 outwards, allowing the front panel 2 to be folded inwards.) Referring to FIGS. 8 and 9, when it is desired to open the upper door 62 on the top panel 6, the user can press a recessed portion of the latch 64 to move the latch 64 into the upper door 62, and thereby lift up the upper door 62, as shown in FIGS. 10 and 11, so that pets (such as doves) can be put into or taken from the pet cage assembly 7. Referring to FIG. 12, when it is desired to open the rear door 33 installed on the frame 31 of the rear panel 3, the user can press a recessed portion of the latch 38 to move the latch 38 into the rear door 33, as shown in FIG. 13, and thereby pull the rear door 33 outwards, so that the pets (such as doves) in the pet cage assembly 7 are allowed to leave freely. Thus, as shown in FIG. 2, the pet cage assembly 7 is stably assembled by simply engaging the aforesaid components thereof with one another, and moreover, the upper and rear doors 62, 33 can be conveniently opened.

According to the present invention, the pet cage assembly assembled by the foregoing process provides the following advantages:

1. The components of the pet cage assembly can be securely assembled by engaging with one another;

2. The upper door or the rear door installed in the rear panel of the pet cage assembly can be opened by a simple pressing operation, thereby allowing pets to be put into or taken out of the pet cage assembly; and

3. The components of the pet cage assembly are configured to facilitate processing and molding, thereby lowing production costs.

1. A pet cage assembly, comprising two lateral panels, a front panel, a rear panel, a bottom panel attached with a water tray, and a top panel pivotally attached by an upper door, characterized in:
each of the two lateral panels being composed of an upper sub-panel and a lower sub-panel, wherein the upper and lower sub-panels are each formed with fasteners extending inwards from two ends thereof, while the lower sub-panel of each said lateral panel is further formed with an extended, engaging portion at one of the two ends thereof
the front panel being formed with cavities on two lateral edges thereof corresponding to the fasteners extending from the two ends of the upper and lower sub-panels of the lateral panels; and
the rear panel comprising a frame assembled with a rear door, wherein the frame is formed with cavities on two lateral edges thereof corresponding to the fasteners extending from the two ends of the upper and lower sub-panels of the lateral panels;
whereby, the fasteners extending from the two ends of the upper and lower sub-panels of the lateral panels are fastened with the cavities formed correspondingly on the front and rear panels when assembled, and the front panel is fastened to the top panel and retained bilaterally by the engaging portions of the lower sub-panels when assembled, so that the pet cage assembly can be securely assembled by engaging the lateral, front, rear, top and bottom panels with one another.

2. The pet cage assembly as claimed in claim 1, wherein the rear door assembled to the frame of the rear panel has an edge formed with a recess installed with resilient elements, whose outer ends press against a latch so that the latch is resiliently engaged with an edge of the frame.

3. The pet cage assembly as claimed in claim 1, wherein the upper door is connected to an opening formed on a side of the top panel, and the upper door has an edge formed with a recess installed with resilient elements, whose outer ends press against a latch so that the latch is resiliently engaged with an edge of the opening.
